(19) United States
(12) Patent Application Publication
(10) Pub. No.: US 2008/0285740 A1
(43) Pub. Date: Nov. 20, 2008

(54) Method and apparatus for crosstalk estimation

(75) Inventors: Sigurd Schelstraete, Menlo Park, CA (US); Sudhakar Kalluri, Cupertino, CA (US)

Correspondence Address: IP CREATORS, P. O. BOX 2789, CUPERTINO, CA, 95015, US

(73) Assignee: IKANOS Communication, Inc., A California Corporation, Fremont, CA (US)

(21) Appl. No.: 12/082,541

(22) Filed: Apr. 10, 2008

Related U.S. Application Data
(60) Provisional application No. 60/922,675, filed on Apr. 10, 2007.
(60) Provisional application No. 60/916,345, filed on May 7, 2007.
(60) Provisional application No. 60/942,282, filed on Jun. 6, 2007.
(60) Provisional application No. 60/942,287, filed on Jun. 6, 2007.
(60) Provisional application No. 60/977,047, filed on Oct. 2, 2007.

(51) Int. Cl. H04M 3/18

(52) U.S. Cl. 379/406.06

(57) ABSTRACT

A line card including: a co-channel estimator and a code selector. The line card is configured to couple to digital subscriber lines to support multi-tone modulation of communications channels thereon. The co-channel estimator is configured to estimate co-channel crosstalk coupling coefficients among selected pairs of the subscriber lines at levels for which the total crosstalk into a selected victim line among the plurality of digital subscriber lines substantially corresponds to the sum of the products of the corresponding crosstalk coupling coefficient for each remaining disturber one of the plurality of subscriber lines and a corresponding substantially unique vector transmitted thereon. The code selector couples to the co-channel estimator. The code selector is configured to select a cross-talk estimation code type and to generate substantially unique code vectors derived there from for injection into selected ones of the of subscriber lines.

### CROSS REFERENCE TO RELATED APPLICATION

This application claims the benefit of prior filed co-pending Provisional Application No. 60/922,675 filed on Apr. 10, 2007 entitled “Estimation of Crosstalk Channels” (Attorney Docket: VELCP073P), co-pending Provisional Application No. 60/916,345 filed on May 7, 2007 entitled “Startup Signal for Vectored DMT Transmission Using Pilot Sequences” (Attorney Docket: VELCP074P), co-pending Provisional Application No. 60/942,282 filed on Jun. 6, 2007 entitled “CAZAC Pilot Sequences for Crosstalk Channel Estimations” (Attorney Docket: VELCP075P), co-pending Provisional Application No. 60/942,287 filed on Jun. 6, 2007 entitled “Tone-Interleaved Pilot Sequences for Crosstalk Channel Estimation” (Attorney Docket: VELCP076P) and co-pending Provisional Application No. 60/977,047 filed on Oct. 2, 2007 entitled “Exact Crosstalk Channel Estimation with m-Sequence Pilots” (Attorney Docket: VELCP079P), all of which are incorporated herein by reference in their entirety as if fully set forth herein.

### BACKGROUND OF THE INVENTION

1. Field of Invention

The field of the present invention relates to multi-tone transceivers.

2. Description of the Related Art

In a digital multi-tone (DMT) based digital subscriber line (DSL) systems (such as ADSL, ADSL2, ADSL2+, VDSL1, VDSL2), the central office (CO) of the telephone company typically includes racks of line cards each servicing many subscriber lines. Each line card includes many chips handling the digital and analog portions of communications over the subscriber lines. Each communication channel modulated onto a corresponding one of the digital subscriber lines is subject to crosstalk from communications channels modulated onto remaining ones of the digital subscriber lines. This crosstalk degrades the performance of each digital subscriber line. What is needed is a method for accurately estimating crosstalk among a plurality of digital subscriber lines.

### SUMMARY OF THE INVENTION

A method and apparatus for crosstalk channel estimation among a plurality of digital subscriber lines each supporting multi-tone modulation of communications channels thereon. In an embodiment of the invention a line card is disclosed. The line card is configured to couple to a plurality of digital subscriber lines to support multi-tone modulation of communications channels thereon. The line card includes: a co-channel estimator and a code selector. The co-channel estimator is configured to estimate co-channel crosstalk coupling coefficients among selected pairs of the plurality of subscriber lines at levels for which the total crosstalk into a selected victim line among the plurality of digital subscriber lines substantially corresponds to the sum of the products of the corresponding crosstalk coupling coefficient for each remaining disturber one of the plurality of subscriber lines and a corresponding substantially unique vector transmitted thereon. The code selector couples to the co-channel estimator. The code selector is configured to select a cross-talk estimation code type and to generate substantially unique code vectors derived there from for injection into selected ones of the plurality of subscriber lines.

In an alternate embodiment of the invention a method is disclosed for estimating crosstalk coupling coefficients on a plurality of digital subscriber lines supporting multi-tone modulation of communications channels thereon. The method comprises;
selecting a cross-talk estimation code type;
injecting the unique code vectors associated with the code type selected in the selecting act into selected ones of the plurality of subscriber lines; and
estimating co-channel crosstalk coupling coefficients among selected pairs of the plurality of subscriber lines at levels for which the total crosstalk into a selected victim line among the plurality of digital subscriber lines substantially corresponds to the sum of the products of the corresponding crosstalk coupling coefficient for each remaining disturber one of the plurality of subscriber lines and a corresponding substantially unique vector transmitted thereon.

In still another embodiment of the invention a means for estimating crosstalk coupling coefficients on a plurality of digital subscriber lines supporting multi-tone modulation of communications channels thereon, is disclosed. The means for estimating crosstalk comprises;
means for selecting a cross-talk estimation code type;
means for injecting the unique code vectors associated with the code type selected by the means for selecting into selected ones of the plurality of subscriber lines; and
means for estimating co-channel crosstalk coupling coefficients among selected pairs of the plurality of subscriber lines at levels for which the total crosstalk into a selected victim line among the plurality of digital subscriber lines substantially corresponds to the sum of the products of the corresponding crosstalk coupling coefficient for each remaining disturber one of the plurality of subscriber lines and a corresponding substantially unique vector transmitted thereon.

### BRIEF DESCRIPTION OF THE DRAWINGS

These and other features and advantages of the present invention will become more apparent to those skilled in the art from the following detailed description in conjunction with the appended drawings in which:

FIG. 1 is a system diagram of an XDSL communication system servicing homes and businesses from a central office;

FIG. 2 is a hardware block diagram showing an embodiment of the line cards of the current invention in the central office shown in FIG. 1.

FIG. 3 is a detailed hardware block diagram of an embodiment of a portion of one of the line cards shown in FIG. 2;

FIG. 4 is a detailed hardware block diagram of the crosstalk estimators shown in FIGS. 2-3;

FIG. 5A is a frame diagram showing XDSL frame types supported by the crosstalk estimator of the current invention;

FIG. 5B is a cross-sectional view of bundles of digital subscriber line bundles with differing types of communication channels the estimation of cross-talk within which requires differing code types;

FIG. 5C shows data structures associated with differing crosstalk estimation code types;

FIGS. 6A-6B show data structures maintained by the local or global crosstalk estimators in an embodiment of the invention for co-channel estimation and crosstalk estimation code generation;

FIG. 7 shows a representative crosstalk coupling coefficient matrix during successive estimation rounds showing carry forward of qualified crosstalk coupling coefficients from prior rounds;

FIG. 8 is a graph showing representative iterative crosstalk coupling coefficient estimations on a single tone of a digital subscriber line during a transition from a first crosstalk code type to a second crosstalk code type; and

FIG. 9 is a process flow diagram of an embodiment of the processes performed by the crosstalk estimators shown in FIGS. 2-3.

### DETAILED DESCRIPTION OF THE EMBODIMENTS

A method and apparatus is disclosed for crosstalk channel estimation among a plurality of digital subscriber lines each supporting multi-tone modulation of communications channels thereon. The line cards may be found in a central office, remote access terminal, business or home. The line cards may be coupled directly or indirectly to digital subscriber lines via one or more optical or wireless links. The line cards support communication channels with differing degrees of robustness for multi-tone protocols including: asymmetric digital subscriber line (ADSL); very high bit rate digital subscriber line (VDSL) and other orthogonal frequency division multiplexing (OFDM) plans including but not limited to the following:

TABLE 1

| | | Down- | | | |
|---|---|---|---|---|---|
| | | stream | | Upstream | |
| Standard name | Common name | rate | | rate | |
| ANSI T1.413-1998 | ADSL | 8 | Mbit/s | 1.0 | Mbit/s |
| Issue 2 | | | | | |
| ITU G.992.1 | ADSL (G.DMT) | 8 | Mbit/s | 1.0 | Mbit/s |
| ITU G.992.1 Annex A | ADSL over POTS | 8 | Mbit/s | 1.0 | MBit/s |
| ITU G.992.1 Annex B | ADSL over ISDN | 8 | Mbit/s | 1.0 | MBit/s |
| ITU G.992.2 | ADSL Lite (G.Lite) | 1.5 | Mbit/s | 0.5 | Mbit/s |
| ITU G.992.3/4 | ADSL2 | 12 | Mbit/s | 1.0 | Mbit/s |
| ITU G.992.3/4 | ADSL2 | 12 | Mbit/s | 3.5 | Mbit/s |
| Annex J | | | | | |
| ITU G.992.3/4 | RE-ADSL2 | 5 | Mbit/s | 0.8 | Mbit/s |
| Annex L | | | | | |
| ITU G.992.5 | ADSL2+ | 24 | Mbit/s | 1.0 | Mbit/s |
| ITU G.992.5 | RE-ADSL2+ | 24 | Mbit/s | 1.0 | Mbit/s |
| Annex L^{[1]} | | | | | |
| ITU G.992.5 Annex M | ADSL2 + M | 24 | Mbit/s | 3.5 | Mbit/s |
| ITU G.993.1 | VDSL | | | | |
| ITU G.993.2 | VDSL 2 | | | | |
| IEEE 802.16e | WiMax | | | | |
| IEEE 802.20 | Mobile Broadband | 1 | Mbit/s | 1 | Mbit/s |
| | Wireless | | | | |
| | Access | | | | |

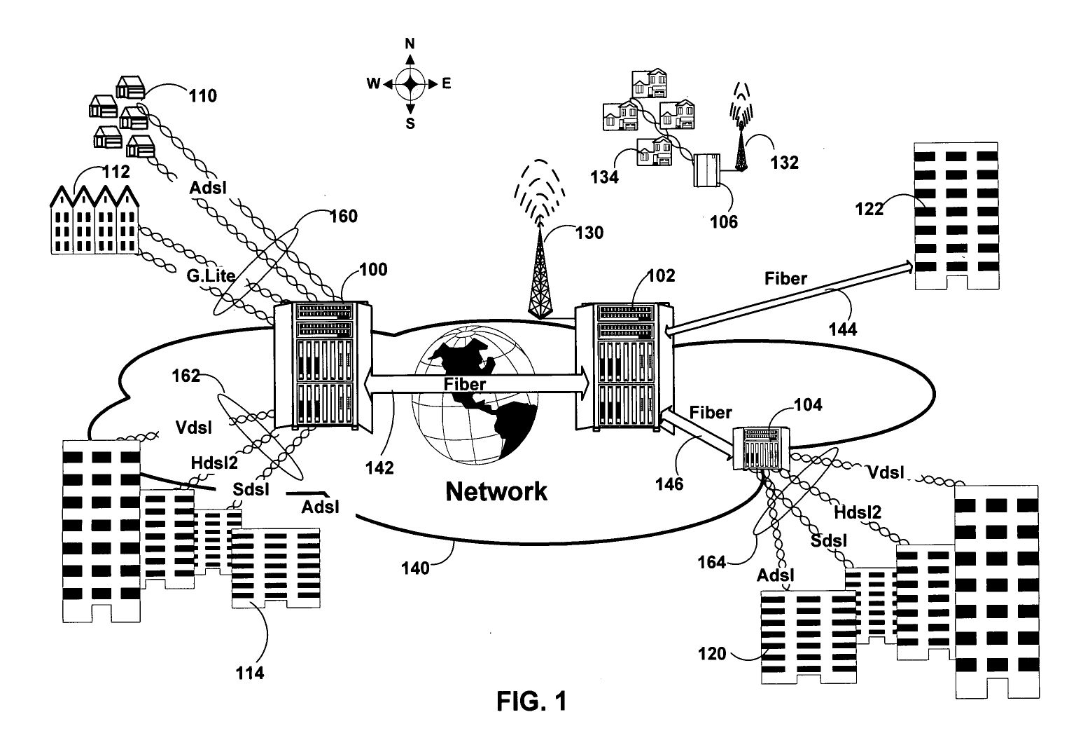

FIG. 1 is a system diagram of an XDSL communication system in which individual subscribers are coupled across public service telephone network (PSTN) subscriber lines with one or more high speed networks. Telephone company's central offices (CO) 100, 102, 106 and remote access terminal 104 are shown coupling various subscribers to one another and to a high speed network 140. The high speed network 140 provides fiber optic links between the central office and remote access terminal. CO's 100-102 are coupled to one another via fiber optic link 142. CO 102 couples to remote access terminal 104 via fiber optic link 146. CO also couples to subscriber site 122 via fiber optic link 144. CO 102 and CO 106 couple to one another via a wireless link provided by corresponding wireless transceivers 130 and 132 respectively. The “last mile” connecting each subscriber, (except subscriber 122) is provided by twisted copper PSTN telephone lines. On these subscriber lines voice band and data communication are provided. The data communication is shown as various X-DSL protocols including G.Lite, ADSL VDSL, and HDSL2. CO 100 is coupled via G.Lite and ADSL modulated subscriber line connections in bundle 160 with subscribers 110 and 112. CO 100 is also coupled via G.Lite and ADSL modulated subscriber line connections in bundle 162 with subscriber 114. CO 106 is also coupled via a subscriber line to subscriber 134. Remote access terminal is coupled via subscriber line connections in bundle 164 with subscribers 120. In each CO or remote access terminal one or more line cards including crosstalk estimation features in accordance with the current invention may advantageously be provided with the added benefit of increased efficiency in the transport of XDSL communication channels over corresponding XDSL subscriber lines. The apparatus and method of the current invention is suitable for handling crosstalk channel estimation on any of these subscriber lines.

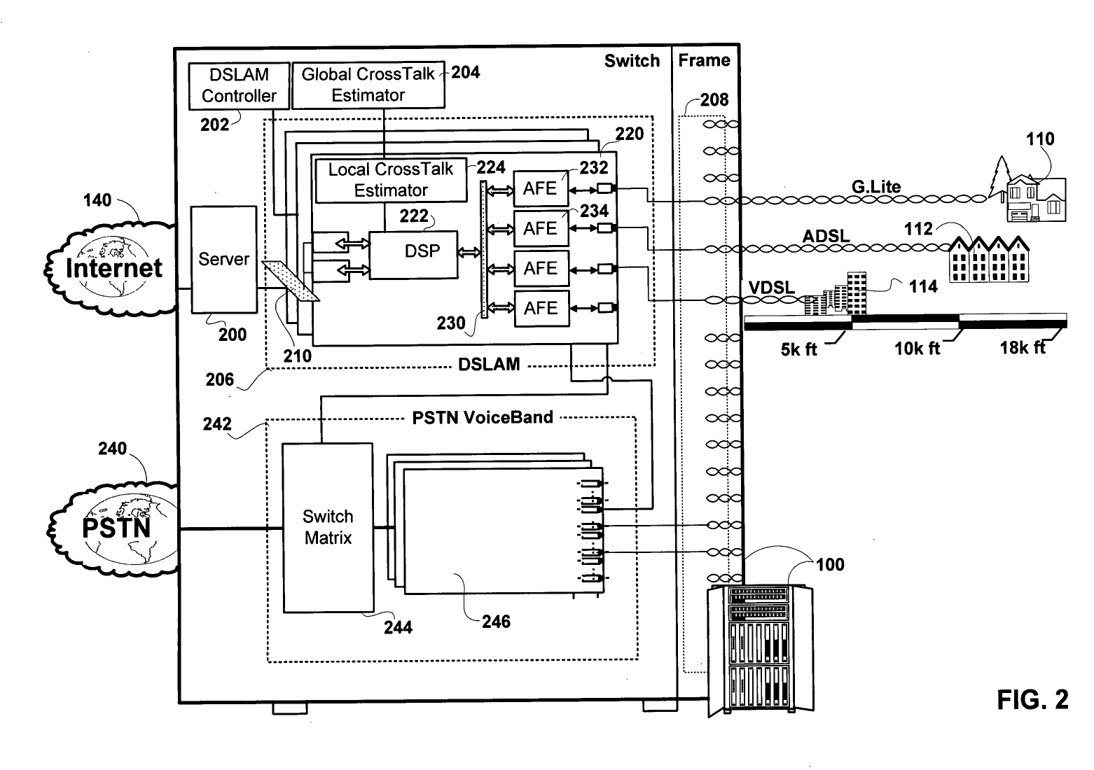

FIG. 2 is a hardware block diagram showing an embodiment of the line cards of the current invention in a representative one of the central offices shown in FIG. 1 including both digital subscriber line access modules (DSLAMs) and PSTN voice band modules. The CO 100 includes subscriber line bundled connections to subscribers 110-114. Each of these connections terminates in the frame room 208 of the CO. From this room connections are made for each subscriber line via splitters and hybrids to both a DSLAM 206 and to the voice band racks 242. The splitter shunts voice band communications to dedicated line cards, e.g. line card 246 or to a voice band modem pool (not shown). The splitter shunts higher frequency X-DSL communications on the subscriber line to a selected line card 220 within DSLAM 206. The line cards of the current invention are universal, meaning they can handle any current or evolving standard of X-DSL and may be upgraded on the fly to handle new standards.

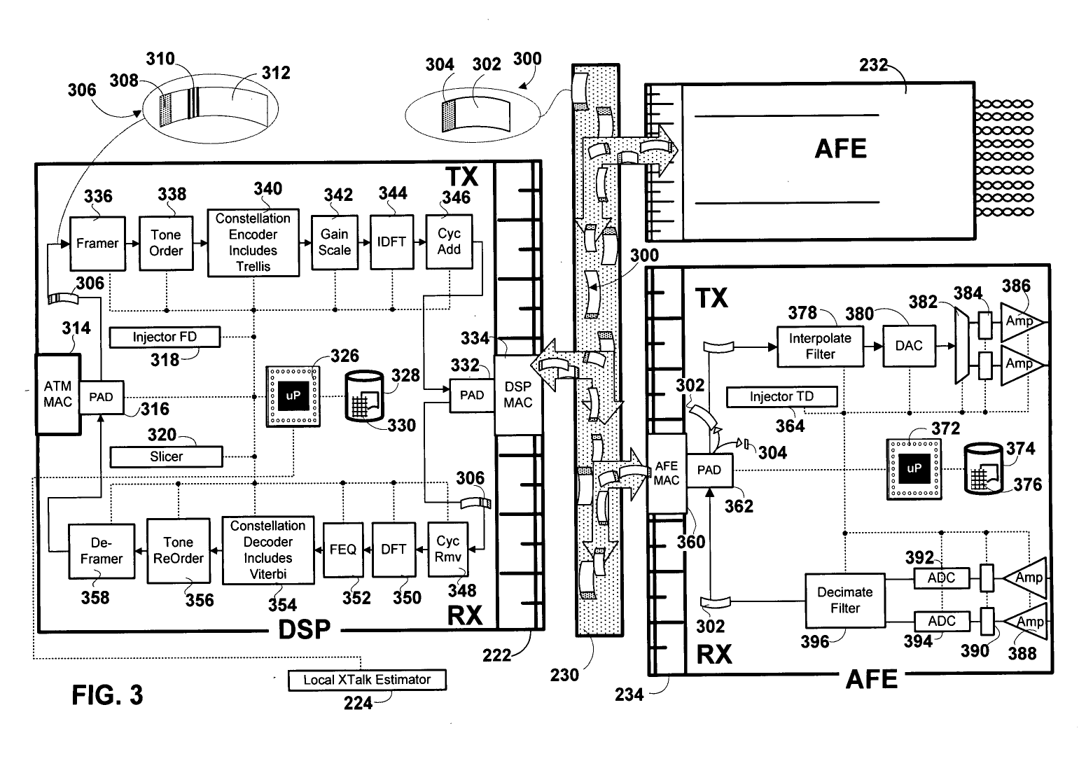

Voice band call set up between subscribers on the public switched telephone network (PSTN) 240 is controlled by a Telco switch matrix 244 implementing a switching protocol such as the common channel signaling system 7 (SS7) for setting up and tearing down a connection via an associated one of the voice band line cards, e.g. line card 246. This makes point-to-point connections to other subscribers for voice band communications. The X-DSL communications may be processed by a universal line card such as line card 220. That line card includes a plurality of AFE's e.g. 232-234 each capable of supporting a plurality of subscriber lines. The AFEs may be coupled directly or as in this embodiment of the invention via a packet based bus 230 to a DSP 222 which is also capable of multi-protocol support for all subscriber lines to which the AFE's are coupled. The line card may include more than one DSP. Crosstalk channel estimation between line cards and among the subscriber lines to which each line card is coupled is handled by a global crosstalk estimator 204 and optional local power allocators, e.g. local crosstalk estimator 224, on each line card. The line card itself is coupled to a back-plane bus 210 which may in an embodiment of the invention be capable of offloading and transporting low latency X-DSL traffic between other DSPs for load balancing. Communications between AFE's and DSP(s) are in an embodiment of the invention packet based which allows a distributed architecture such as will be set forth in the following FIG. 3 to be implemented. Each of the DSLAM line cards operates under the control of a DSLAM controller 202 which handles global provisioning, e.g. allocation of subscriber lines to AFE and DSP resources. Once an X-DSL connection is established between the subscriber and a selected one of the DSLAM sub modules, e.g. AFE and DSP, the subscriber will be able to access any network, e.g. the Internet 140, to which the DSLAM is connected.

FIG. 3 is a detailed hardware block diagram of an embodiment of a portion of one of the line cards shown in FIG. 2 in which multiple analog front end (AFE) chips 232-234 connect with one or more digital signal processing (DSP) chips, e.g. DSP, 222 across bus 230. In an alternate embodiment of the invention each AFE has separate ports for each subscriber line connection which are coupled directly to an associated port of the corresponding DSP, thereby obviating the need for a bus. These digital and analog chips are all mounted on the line card 220 shown in FIG. 2. A single line card may currently support 64 to 128 ports each handling communications of an associated one of the digital subscriber lines. In the embodiment of the line card shown in FIG. 3, packets of raw data are shown being transported between the DSP and AFEs as well as within each DSP and AFE. Packet processing between the DSP and AFE chips involves transfer of bus packets 300. Packet processing within a DSP may involve device packets 306. Packet processing within an AFE may involve raw data packets 302. These will be discussed in the following text. In this embodiment of the invention, a local crosstalk estimator 224 is coupled to the DSP and through it to the AFEs to control crosstalk estimation for communications over each subscriber line serviced by the line card. In an alternate embodiment of the invention the global crosstalk estimator 204 (See FIG. 2) would directly couple to the DSP(s) on each line card and through them to the associated AFEs to control crosstalk estimation for all the digital subscriber lines to which the various line cards are coupled.

These modules, AFE and DSP, may be found on a single universal line card, such as line card 220 in FIG. 2. They may alternately be displaced from one another on separate line cards linked by a DSP bus. In still another embodiment they may be found displaced from one another across an ATM network. There may be multiple DSP chipsets on a line card. In an embodiment of the invention the DSP and AFE chipsets may include structures set forth in the figure for handling of multiple line codes and multiple channels.

The DSP chip 222 includes an upstream (receive) and a downstream (transmit) processing path with both discrete and shared modulation and demodulation modules or components. The components are configurable on the fly to process each packet of data in a manner consistent with the characteristics of the corresponding subscriber line over which the packet will be transported, the assigned modulation protocol for that line and the service level assigned to the subscriber. The modules or components may be implemented in hardware, firmware or software without departing from the scope of the claimed invention. In an embodiment of the invention selected ones of the modules are responsive to packet header information and/or control information to vary their processing of each packet to correspond with the X-DSL protocol and line code and channel which corresponds with the packet contents. Data for each of the channels is passed along either path in discrete packets the headers of which identify the corresponding channel and may additionally contain channel specific control instructions for various of the shared and discrete components along either the transmit or receive path.

On the upstream path, upstream packets containing digital data from various of the subscribers is received by the DSP medium access control (MAC) 334 which handles packet transfers to and from the DSP bus. The MAC couples with a packet assembler/disassembler (PAD) 332. For upstream packets, the PAD handles removal of the DSP bus packet header 304 and the packaging of the data 312 into a device packet 306 which includes a device header 308 and a control header 310. The content of these headers is generated by the core processor 326 using information downloaded from the DSLAM controller 202 (See FIG. 2) as well as statistics such as gain tables gathered by the de-framer 358, or embedded operations channel communications from the subscriber side. These channel specific and control parameters 330 are stored in memory 328 which is coupled to the core processor. The PAD 332 embeds the required commands generated by the core processor in the header or control portions of the device packet header of the upstream data packets. The upstream packets may collectively include data from multiple channels each implementing various ones of the X-DSL protocols. Thus the header of each device packet identifies the channel corresponding with the data contained therein. Additionally, a control portion of the packet may, in an embodiment of the invention, include specific control instructions for any of the discrete or shared components which make up the upstream or downstream processing paths.

Upstream processing in the DSP begins with the removal of the cyclic prefix/suffix in module 348. Next in the discrete Fourier transform module (DFT) 350 received data from each subscriber line is transformed from the time to the frequency domain. In this embodiment of the invention, the information in the header of the packet is used to maintain channel identity of the data as it is demodulated. The DFT is responsive to the header information in each packet to setup the transform with the appropriate parameters for that channel, e.g. sample size, and to provide channel specific instructions for the demodulation of the data. The demodulated data is passed as a packet to the next component in the upstream path, i.e. the frequency error corrector (FEQ) 352. Next constellation decoding, including Viterbi decoding, takes place in component 354. Then the tones are reordered in the tone reorderer 356 and deframed in the deframer and Reed Solomon decoder 358. This component reads each device packet header and processes the data in it in accordance with the instructions or parameters in its header. The demodulated, decoded and de-framed data is passed to PAD 316. In PAD 316 the device packet header is removed and the demodulated data contained therein is wrapped with an asynchronous transfer mode (ATM) or other network header and passed to the medium access control (MAC) 314 for transmission over the ATM or other network to which the line card is coupled (See FIGS. 1-2).

On the downstream path, downstream packets containing digital data destined for various subscribers is received by the MAC 314 and passed to the PAD 316 where the ATM or other header is removed and the downstream device packet 306 is assembled. Using header content generated by the core processor 326 the PAD assembles data from the ATM or other network into channel specific packets each with their own header 308, data 312 and control 310 portions. The downstream packets are then passed to the Framer and Reed Solomon encoder 336 where they are processed in a manner consistent with the control and header information contained therein. From the framer packets are subject to tone ordering in the tone orderer 338 and to constellation encoding, including trellis encoding, in the constellation encoder 340. Gain scaling is performed in the gain scaler 342. Next downstream packets are passed to the inverse discrete Fourier transform component/module 344 (IDFT) for transformation from the frequency to the time domain. The setup of the IDFT is re-configured on the fly to match the requirements assigned to each packets corresponding channel or subscriber line. The addition of any cyclic extensions is performed in cyclic extension adder 346. Next, each downstream packet with the modulated data contained therein is then passed to the PAD 332. In the PAD 332 the device packet header and control portions are removed, and a DSP bus header 304 is added to the data 302. This header identifies the specific channel and may additionally identify the sending DSP, the target AFE, the packet length and such other information as may be needed to control the receipt and processing of the packet by the appropriate AFE. The packet is then passed to the MAC 334 for placement on the DSP bus 230 for transmission to the appropriate AFE.

In this embodiment of the invention each DSP includes an injector 318 and a slicer 320. The injector under control of the local or global crosstalk estimators injects the unique code vectors provided thereby into each communication channel, and specifically a target portion thereof. This injection occurs in the frequency domain. In an embodiment of the invention that targeted portion is identified as a synchronization symbol which occupies a portion of each set of frames identified as a super frame. In various embodiments of the invention the injection may take place simultaneously across all subscriber lines to which the DSP is coupled, or alternately in round robin fashion across one subscriber line at a time.

The DSP in this embodiment of the invention also includes a slicer 320. This slicer handles the slicing of the corrupted synch symbol from the received communication channel in an embodiment of the invention. Alternately, where injection occurs only on the CO side slicer 320 is inoperative for the synchronization symbols. In still another embodiment of the invention the slicer may subtractively remove the unique code vector associated with the corrupted synchronization symbol and transport same either directly or via an upstream channel to the local crosstalk estimator.

The crosstalk estimators may operate during either or both the training or showtime phase of each communication channel or subscriber line's operation.

FIG. 3 also shows a more detailed view of the processing of upstream and downstream packets within the AFE 234. In the embodiment of the invention shown, device packets are not utilized in the AFE. Instead, channel and protocol specific processing of each packet is implemented using control information for each channel stored in memory at session setup. Each AFE chip 234 includes an upstream (receive) and a downstream (transmit) processing path with both discrete and shared modulation and demodulation modules or components. The components are configurable on the fly to process each packet of data in a manner consistent with the characteristics of the corresponding subscriber line over which the packet will be transported, the assigned modulation protocol for that line and the service level assigned to the subscriber.

Downstream packets from the DSP are pulled off the bus 230 by the corresponding AFE MAC, e.g. MAC 360, on the basis of information contained in the header portion of that packet. Each downstream packet is passed to PAD 362 which removes the header 304 and sends it to the core processor 372. The core processor matches the information in the header with channel control parameters 376 contained in memory 374. These control parameters may have been downloaded to the AFE at session setup. The raw data 302 portion of the downstream packet is passed to interpolator and filter 378. The interpolator up-samples the data and low pass filters it to reduce the noise introduced by the DSP. Implementing interpolation in the AFE as opposed to the DSP has the advantage of lowering the bandwidth requirements of the DSP bus 230. From the interpolator data is passed to a digital-to-analog converter (DAC) 380 which processes each channel in accordance with commands received from the core processor 372 using the control parameters downloaded to the control table 376 during channel setup. The analog output of the DAC is passed via analog mux 382 to a corresponding one of sample and hold devices and analog filters 384. Each sample and hold and filter is associated with a corresponding subscriber line. The sampled data may be amplified by line amplifiers 386. The parameters for each of these devices, i.e. filter coefficients, amplifier gain etc. are controlled by the core processor using the above discussed control parameters 376. For example, where successive downstream packets carry downstream channels each of which implements different protocols, e.g. G.Lite, ADSL, and VDSL the sample rate of the analog mux 382 the filter parameters for the corresponding filter and the gain of the corresponding one of analog amplifiers 386 will vary for each packet. This “on the fly” configurability allows a single downstream pipeline to be used for multiple concurrent protocols.

On the upstream path many of the same considerations apply. Individual subscriber lines couple to individual line amplifiers 388 through splitter and hybrids (not shown). Each channel is passed through analog filters and sample and hold modules 390 and dedicated analog-to-digital conversion (ADC) modules 392-394. As discussed above in connection with the downstream/transmit path, each of these components is configured on the fly for each new packet depending on the protocol associated with it. From each ADC fixed amounts of data for each channel, varying depending on the bandwidth of the channel, are processed by the decimator and filter module 396. The amount of data processed for each channel is determined in accordance with the parameters 376 stored in memory 374. Those parameters may be written to that table during the setup phase for each channel.

From the decimator and filter the raw upstream data 302 is passed to PAD 362 during each bus interval. The PAD wraps the raw data in a DSP header 304 with channel ID and other information which allows the receiving DSP(s) to properly process it. The upstream packet is placed on the bus by the MAC 360. A number of protocols may be implemented on the bus 216. In an embodiment of the invention the DSP operates as a bus master governing the pace of upstream and downstream packet transfer and the AFE utilization of the bus.

In an alternate embodiment of the invention each AFE includes an injector to perform the above discussed injection in the time domain, rather than the frequency domain. In an embodiment of the invention that targeted portion is identified as a synchronization symbol which occupies a portion of each set of frames identified as a super frame. In various embodiments of the invention the injection may take place simultaneously across all subscriber lines to which the DSP is coupled, or alternately in round robin fashion across one subscriber line at a time.

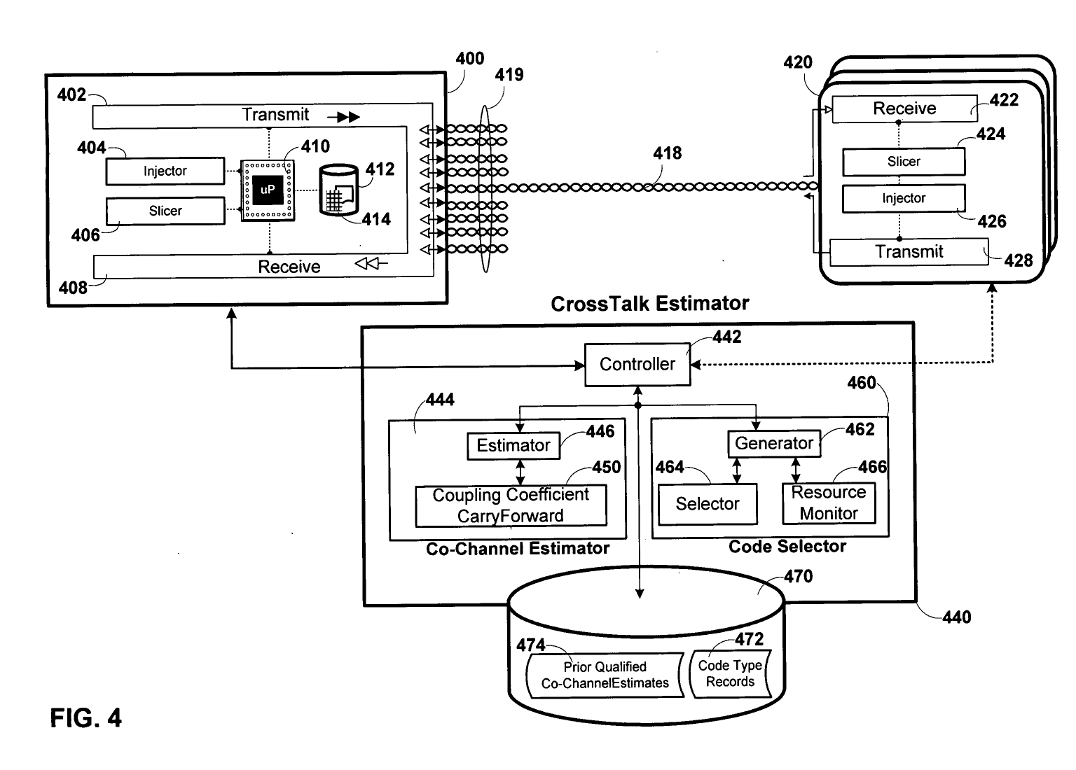

FIG. 4 is a detailed hardware block diagram of the crosstalk estimators shown in FIGS. 2-3. FIG. 4 shows a line card 400 driving a plurality of digital subscriber lines one of which 412 couples at a remote end to a selected one 420 of plurality of multi tone modems. A crosstalk estimator 440 is shown physically coupled to the line card 400 and virtually coupled via an upstream communication channel to the remote modem 420. A memory 470 is shown coupled to the crosstalk estimator. The line card includes components which provide a transmit path 402 and a receive path 408 for modulating and demodulating communications channels onto the bundle 419 of digital subscriber lines to which the line card is coupled. The line card also includes a processor 410 for controlling the overall operation of the components which make up the transmit and receive paths and an associated memory 412 and records 414 for storage of various control and operational parameters. The line card includes an injector 404 for injecting unique code vectors into the communications channels associated with each of the digital subscriber lines. The line card also includes a slicer 406 for The DSP in this embodiment of the invention also includes a slicer 320. This slicer handles removal of a copy of the corrupted synch symbol from the upstream communication channel of a remote modem 420 the corresponding slicer 424 of which performed the original slicing. In still another embodiment of the invention the slicer 406 may subtractively remove the unique code vector associated with the corrupted synchronization symbol and transport same either directly or via an upstream channel to the local crosstalk estimator. The injector and slicer operate under control of the crosstalk estimator 440.

The remote modem 420 includes a receive path 422 for demodulating a communication channel received over digital subscriber line 418 and a transmit path 428 for modulating the communication channel transmitted over to the digital subscriber line 418 to the line card 400. The remote modem also includes a slicer 424 for slicing the corrupted vector injected into line 418 by injector 404 on the line card. In still another embodiment of the invention the slicer 424 may subtractively remove the unique code vector associated with the corrupted synchronization symbol and transport same either directly or via an upstream channel to the local crosstalk estimator. The remote modem may also optionally include an injector 426.

Remaining ones of the plurality of remote modems may or may not include support for injection and slicing of unique crosstalk estimation vectors without departing from the scope of the claimed invention.

In the embodiment shown injection of unique cross talk injection vectors into the plurality of digital subscriber lines is accomplished exclusively on the line card 400 on the downstream path to the remote modem 420. In this embodiment slicing of the corrupted crosstalk estimation vector occurs at the remote modem. In alternate embodiments of the invention injection and slicing may be implemented as bidirectional processes without departing from the scope of the claimed invention.

The crosstalk estimator includes a controller 442, a co-channel estimator 444 and a code selector 460. The controller coordinates the interface between the co-channel estimator, the code selector and the injectors and slicers on the line card and remote modem(s). The crosstalk estimators may operate during either or both the training or showtime phase of each communication channel or subscriber line's operation. The crosstalk estimator in an embodiment of the invention couple to more than one line card each driving a set of digital subscriber lines, all of which sets may form a bundle in which co-channels coefficients may be estimated within the scope of the current invention.

The co-channel estimator is configured to estimate co-channel crosstalk coupling coefficients among selected pairs of the plurality of subscriber lines at levels for which the total crosstalk into a selected victim line among the plurality of digital subscriber lines substantially corresponds to the sum of the products of the corresponding crosstalk coupling coefficient for each remaining disturber one of the plurality of subscriber lines and a corresponding substantially unique vector transmitted thereon. Where the disturber is associated with a communication channel which supports dynamic synchronization symbol modulation the unique vector corresponds to the unique code vector associated with selected code type injected by the injector. Where the disturber is associated with a communication channel which does not support dynamic synchronization symbol modulation the unique vector corresponds to the data transmitted on the corresponding portion of the communication channel.

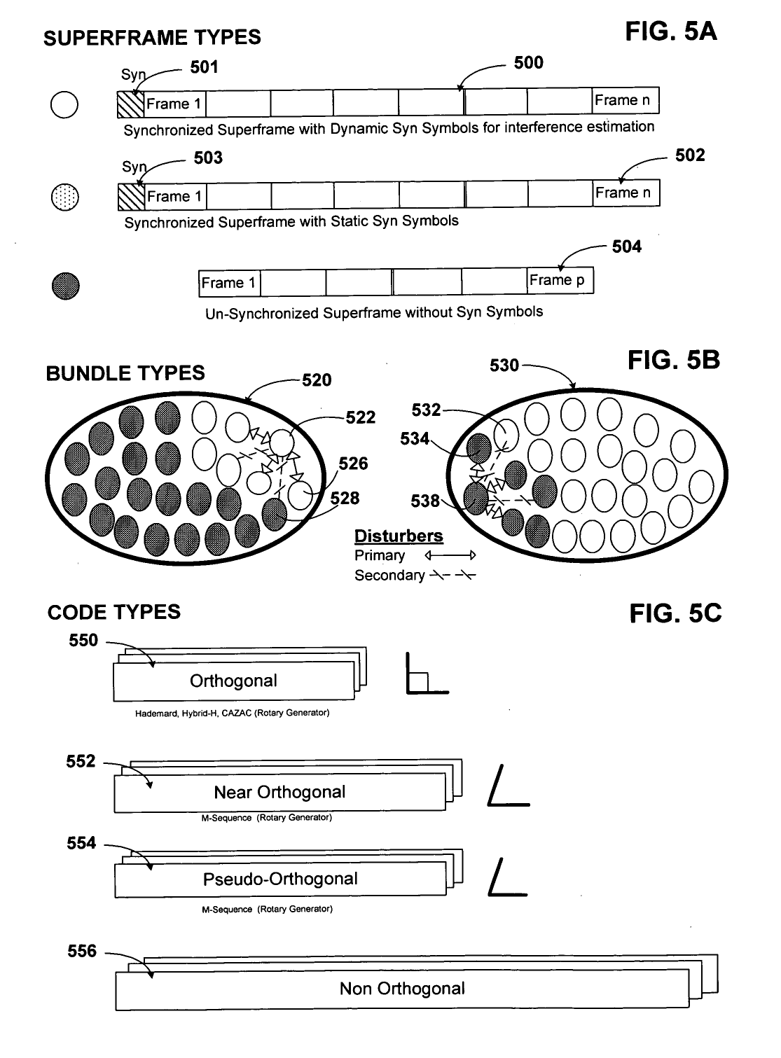

The co-channel estimator includes an estimator 446 which handles estimation of crosstalk coupling coefficients for all the subscriber lines in the bundle 419 whether or not they include support for the injection of unique code vectors or the corresponding slicing. Thus the co-channel estimator allows for co-channel estimation for a variety of different subscriber line bundle types (See FIG. 5B). In another embodiment of the invention the estimator is further configured to iteratively estimate crosstalk coupling vectors and to average the variation in the co-channel coupling coefficients across iterations. In still another embodiment of the invention the estimator iteratively estimates crosstalk coupling vectors including at least one portion overlapping with the estimation of a prior portion thereby reducing a time required for multiple iterations of the estimation of the cross-talk coupling coefficients of a selected code type.

In this embodiment of the invention a coupling coefficient carry forward component 450 handles the determination of which co-channels estimated by the estimator qualify for inclusion in a subsequent estimation pass with a different crosstalk estimation code type and for carrying forward said qualified co-channel estimates for such use by the estimator, thereby reducing processing complexity and time associated with the estimation performed by the co-channel estimator. In an embodiment of the invention the coupling coefficient carry forward component stores prior qualified co-channel estimates 474 in memory 470.

The code selector 460 is coupled to the controller and the co-channel estimator and is configured to select a cross-talk estimation code type and for generating substantially unique code vectors derived there from for injection into selected ones of the plurality of subscriber lines. In an embodiment of the invention each cross-talk estimation code type is stored as a corresponding record 472 in memory 470. Each record may be a complete expression of the code type and all unique vectors associated therewith. Alternately each record may include a seed, a kernel, or a base code associated with the code type and one or more instructions related to the generation of unique code vectors derived from same. Additionally each record may include detailed functions or instructions related to the procedures and steps related to estimating the co-channel coefficients based on the selected code type. The code selector in this embodiment of the invention includes: a generator 462, a selector 464 and a resource monitor 466. The generator handles the generation of unique code vectors for a code type selected by the selector 464. The resource monitor monitors available resources on the line card. The selector couples to the resource monitor and the generator for selecting the cross-talk estimation code type from memory 470 for which the associated resource consumption falls within the available resources monitored by the resource monitor. Additional criteria for the selection of code type includes the extent to which the bundle of subscriber lines includes modems which support dynamic injection of unique code vectors and the slicing of corrupted received counterparts thereof from each received communication channel.

The controller 442 interfaces with the slicers and injectors to control their setup and operation. In an embodiment of the invention the injector 404 is responsive to an initialization of a new one of the plurality of digital subscriber lines to order the injection of unique code vectors into selected ones of the plurality of digital subscriber lines in a round-robin fashion thereby limiting crosstalk coupling coefficient estimation by the co-channel estimator during each iteration to that associated with a single disturber among the plurality of digital subscriber lines. In another embodiment of the invention the injector limits transmission on a newly activated communication channel on a subscriber line during co-channel estimation exclusively to a corresponding one of the substantially unique code vectors from the code selector and without additional data transmission thereon. In still another embodiment of the invention the injector generates the unique code vector for each selected one of the plurality of digital subscriber lines by offsetting by a random amount unique to each selected one of the plurality of digital subscriber lines a seed vector of a selected crosstalk estimation code type selected by the code selector.

FIG. 5A is a frame diagram showing different XDSL super frames: 500, 502 and 504. Super frames 500 and 502 includes multiple frames and a pilot sequence used for synchronization purposes. In VDSL-2 the super frame pilot sequence is identified as a synchronization symbol 501, 503. The synchronization symbol 501 in super frame 500 is identified as dynamic in that the communication channel modulated thereon along with the actual modems modulating the communication channel support dynamic modulation of the synchronization symbol with the substantially unique code vector injected thereon under control of the associated crosstalk estimator. The synchronization symbol 503 in super frame 502 is identified as static in that either the protocol associated with the communication channel does not provide a synchronization symbol, or a supported super frame size or the opposing modems modulating the communication channel do not support dynamic modulation of a synchronization symbol. The super frame 504 does not include a synchronization symbol and is not the same length as either of super frames 500 and 502. Each of these super frames is identified with a corresponding cross sectional indicator for reference in connection with the following FIG. 5B.

FIG. 5B is a cross-sectional view of two bundles of digital subscriber lines 520 and 530 exhibit different mixes of communication channels. Bundle 530 includes primarily communication channels which support dynamic synchronization symbol modulation while bundle 520 does not. Subscriber lines having communication channels which support dynamic synchronization symbol modulation include lines 532 in bundle 530 and lines 522 and 526 in bundle 520. Subscriber lines having communication channels which do not support dynamic synchronization symbol modulation include lines 534 and 538 in bundle 530 and line 528 in bundle 520.

FIG. 5C shows data structures associated with differing crosstalk estimation code types. Orthogonal code types 550 include: Hadamard code type, Hybrid-Hadamard code type (see following discussion) and CAZAC code type. Near orthogonal code types 552 include: m-sequence code type. Pseudo-orthogonal code types 554 include hybrid-m-sequence code type (see following discussion). Non-orthogonal code types 556 include error estimation using raw data. The crosstalk estimator of the current invention utilized one or more of the above referenced code types singly or in combination to estimate all co-channel coefficients in the associated bundle.

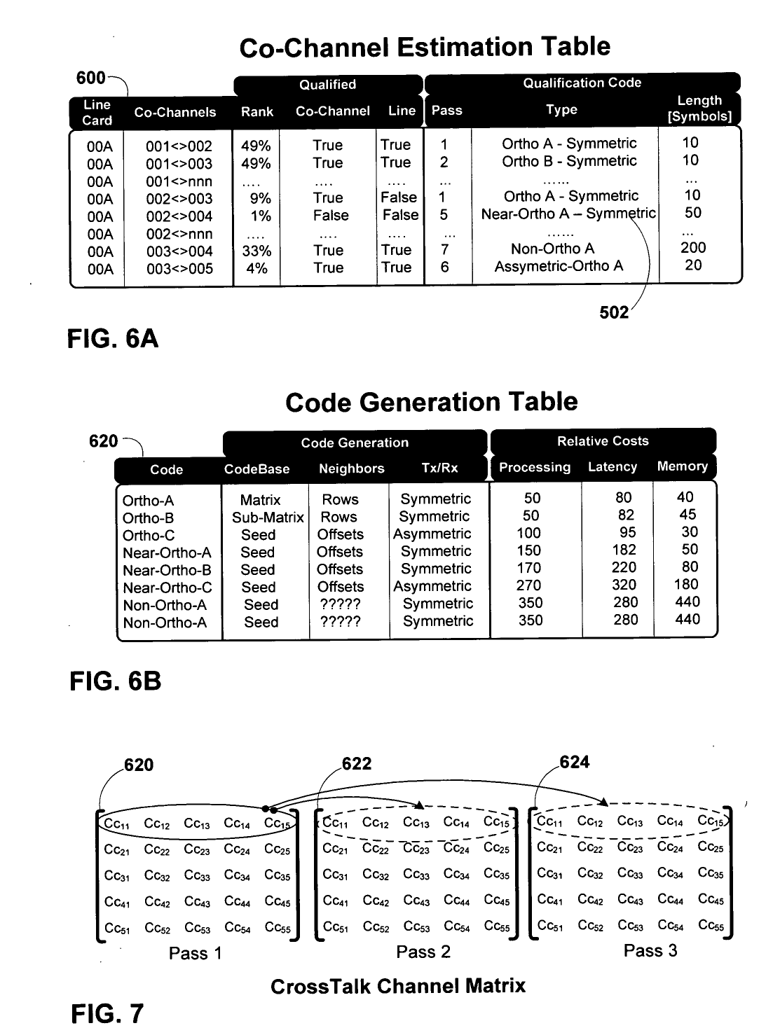

FIGS. 6A-6B show data structures maintained by the local or global crosstalk estimators in an embodiment of the invention for co-channel estimation and crosstalk estimation code generation.

In FIG. 6A individual records of a co-channel estimation table maintained by the crosstalk estimator are shown. Each row corresponds to a record for a given co-channel its ranking among disturbers, whether it is qualified in a prior estimation by a prior code type at either or both the co-channel or line level, the code type pass on which qualification was achieved, the code type used for qualification and the length of the unique code vectors associated with the qualifying pass.

In FIG. 6B a table of code type generation record is shown with each row corresponding to a record. Each cross-talk estimation code type record define either functionally or physically substantially unique code vectors associated with the corresponding cross-talk estimation code type and the relative costs associated with crosstalk estimation therewith. Code types include: orthogonal and non-orthogonal types, binary and complex types. Orthogonal code types include: Hadamard code type, Hybrid-Hadamard code type (see following discussion) and CAZAC code type. Near orthogonal code types include: m-sequence code type. Pseudo-orthogonal code types include hybrid-m-sequence code type (see following discussion). Non-orthogonal code types 556 include error estimation using raw data.

The following is a detailed exposition of a novel cross-talk estimation code types identified respectively as hybrid-M-sequence and hybrid-Hadamard.

### Hybrid M-Sequences

M-sequences are not perfectly orthogonal when correlated with themselves. Specifically, the correlation is given by:

$${ρ}_{s} ( u ) = \frac{1}{N} {\sum }_{t = 0}^{N - 1} s ( t ) \cdot s ( ( t + u ) ) = ( 1 + \frac{1}{N} ) \cdot {δ}_{( u )} - \frac{1}{N} . \qquad ( 1 )$$

By using a different sequence for transmission and reception however, the non-orthogonal term can be completely removed. This can be shown as follows.

A key property of binary m-sequences s(t)ε{−1,+1} is that they always sum to unity:

$${\sum }_{t = 0}^{N - 1} s ( t ) ≡ 1. \qquad ( 2 )$$

Using (2) in (1), we can write:

$$\begin{matrix} {ρ}_{s} ( u ) = \frac{1}{N} {\sum }_{t = 0}^{N - 1} s ( t ) \cdot s ( ( t + u ) ) \\ = ( 1 + \frac{1}{N} ) \cdot {δ}_{( u )} - \frac{1}{N} \\ = ( 1 + \frac{1}{N} ) \cdot {δ}_{( u )} - \frac{1}{N} {\sum }_{t = 0}^{N - 1} s ( t ) ,\end{matrix} \\ \frac{2}{N + 1} {\sum }_{t = 0}^{N - 1} s ( t ) \cdot [ \frac{s ( ( t + u ) ) + 1}{2} ] = \frac{2}{N + 1} {\sum }_{t = 0}^{N - 1} s ( t ) \cdot \tilde{s} ( ( t + u ) ) = {δ}_{( u )} . \qquad ( 3 )$$

We see from (3) that although m-sequences s(t)ε{−1,+1} are not perfectly orthogonal to their time-shifted versions, they are orthogonal to the time-shifted versions of a modified sequence \tilde{s}(t)ε{0,+1}. Note that the modified sequence is obtained from the original m-sequence simply by replacing all the −1's with 0's:

$$\tilde{s} ( t ) = \frac{s ( t ) + 1}{2} = \{ \begin{matrix}1 , & s ( t ) = 1 \\ 0 , & s ( t ) = - 1\end{matrix} . \qquad ( 4 )$$

With this property, crosstalk channel estimation with m-sequences does not suffer from any non-orthogonality.

### Hybrid Hadamard

The aim is to construct a sequence that is orthogonal for both a constant and a linear weight function. In other words, the sequence satisfies:

$$\frac{1}{N} {\sum }_{t = 0}^{N - 1} {s}_{n} ( t ) \cdot {s}_{{n}^{′} } ( t ) = {δ}_{{nn}^{′}} \\ \frac{1}{N} {\sum t \cdot }_{t = 0}^{N - 1} {s}_{n} ( t ) \cdot {s}_{{n}^{′} } ( t ) = c ( N ) \cdot {δ}_{{nn}^{′}} \qquad ( 5 )$$

The sequence is of length N and the set of sequences has M members. Below we show a construction procedure that allows us to construct a set of M=N/2 sequences of length N that have the desired properties.

In compact notation, we can write the set of sequences as an M×N matrix S:

$$\begin{matrix}{S}_{nt} = {s}_{n} ( t ) \\ = ( \begin{matrix}{s}_{0} ( 0 ) & {s}_{0} ( 1 ) & … & {s}_{0} ( N - 1 ) \\ {s}_{1} ( 0 ) & {s}_{1} ( 1 ) & … & {s}_{1} ( N - 1 ) \\ ⋮ & & & ⋮ \\ {s}_{M - 1} ( 0 ) & {s}_{M - 1} ( 1 ) & & {s}_{M - 1} ( N - 1 )\end{matrix} )\end{matrix} \qquad ( 6 )$$

The orthogonality conditions can then be written as:

$$\frac{1}{N} S * {S}^{T} = {1}_{M \times M} \\ \frac{1}{N} S * diag ( [ 1 \; 2 … N ] ) {*}^{T} = c ( N ) \cdot {1}_{M \times M} \qquad ( 7 )$$

One can directly verify that for N=4, the following two matrices satisfy these conditions:

$${S}_{4}^{( 1 )} = ( \begin{matrix}1 & 1 & 1 & 1 \\ 1 & - 1 & - 1 & 1\end{matrix} ) \\ {S}_{4}^{( 2 )} = ( \begin{matrix}1 & - 1 & 1 & - 1 \\ 1 & 1 & - 1 & - 1\end{matrix} ) \qquad ( 8 )$$

In addition we have:

S₄⁽¹⁾*S₄⁽²⁾^{^{T}}=0_{2×2} (9)

And the transpose:

S₄⁽²⁾*S₄⁽¹⁾^{^{T}}=0_{2×2} (10)

Using the two matrices S₄⁽¹⁾ and S₄⁽²⁾, one can construct two 4×8 matrices S₈⁽¹⁾ and S₈⁽²⁾ as follows:

$${S}_{8}^{( 1 )} = ( \begin{matrix}{S}_{4}^{( 1 )} & {S}_{4}^{( 1 )} \\ {S}_{4}^{( 2 )} & - {S}_{4}^{( 2 )}\end{matrix} ) = ( \begin{matrix}1 & 1 & 1 & 1 & 1 & 1 & 1 & 1 \\ 1 & - 1 & - 1 & 1 & 1 & - 1 & - 1 & 1 \\ 1 & - 1 & 1 & - 1 & - 1 & 1 & - 1 & 1 \\ 1 & 1 & - 1 & - 1 & - 1 & - 1 & 1 & 1\end{matrix} ) \\ {S}_{8}^{( 2 )} = ( \begin{matrix}{S}_{4}^{( 2 )} & {S}_{4}^{( 2 )} \\ {S}_{4}^{( 1 )} & - {S}_{4}^{( 1 )}\end{matrix} ) = ( \begin{matrix}1 & - 1 & 1 & - 1 & 1 & - 1 & 1 & - 1 \\ 1 & 1 & - 1 & - 1 & 1 & 1 & - 1 & - 1 \\ 1 & 1 & 1 & 1 & - 1 & - 1 & - 1 & - 1 \\ 1 & - 1 & - 1 & 1 & - 1 & 1 & 1 & - 1\end{matrix} ) \qquad ( 11 )$$

Again, one directly verifies that S₈⁽¹⁾ and S₈⁽²⁾ satisfy the orthogonality conditions and that:

S₈⁽¹⁾*S₈⁽²⁾^{^{T}}=0_{4×4}

S₈⁽²⁾*S₈⁽¹⁾^{^{T}}=0_{4×4} (12)

These two examples show how a set of N/2 sequences of length N can be constructed that meet the orthogonality requirements. Note that with this construction, one is actually able to construct two such sets.

The recursion relation is given by:

$${S}_{2 N}^{( 1 )} = ( \begin{matrix}{S}_{N}^{( 1 )} & {S}_{N}^{( 1 )} \\ {S}_{N}^{( 2 )} & - {S}_{N}^{( 2 )}\end{matrix} ) \\ {S}_{2 N}^{( 2 )} = ( \begin{matrix}{S}_{N}^{( 2 )} & {S}_{N}^{( 2 )} \\ {S}_{N}^{( 1 )} & - {S}_{N}^{( 1 )}\end{matrix} ) \qquad ( 13 )$$

It can be shown recursively that S_{2N}⁽¹⁾ and S_{2N}⁽²⁾ meet the orthogonality requirements if S_{N}⁽¹⁾ and S_{N}⁽²⁾ meet these requirements.

One can show that the union of S_{N}⁽¹⁾ and S_{N}⁽²⁾ is a row permutation of the Hadamard matrix of size N. This means that the sequences of a Hadamard matrix of size N can be split in two groups such that the sequence within a group are orthogonal with respect to each other, both for a constant and a linear weight function.

FIG. 7 shows a representative crosstalk coupling coefficient matrix during successive estimation rounds 620, 622, 624 showing carry forward of qualified crosstalk coupling coefficients for the first row of the matrix carried forward to succeeding rounds in which different cross-talk estimation code types are utilized for estimation of remaining unqualified co-channels.

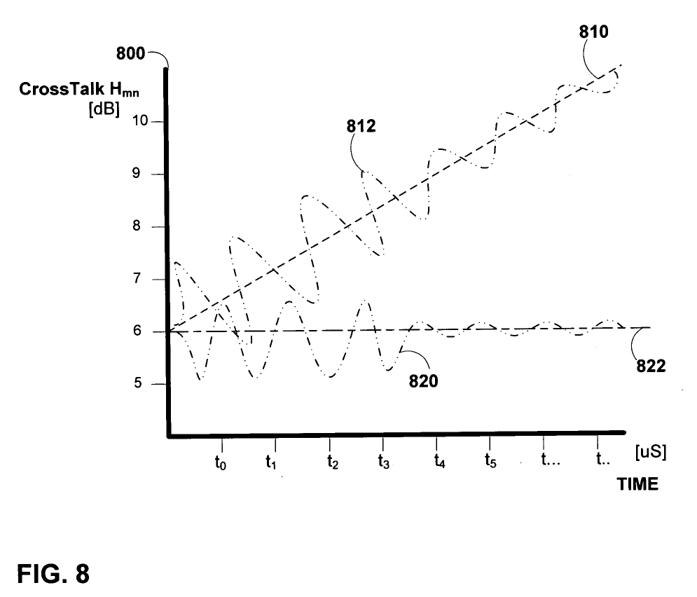

FIG. 8 is a graph of crosstalk vs. time for representative iterative crosstalk coupling coefficient estimations on a single tone of a digital subscriber line during a transition from a first crosstalk code type to a second crosstalk code type at the interval t3-t4. Line 822 corresponds to a steady state condition of the co-channel coefficients. Line 820 corresponds to variances in the crosstalk coupling coefficient estimations during successive iterations of the same cross-talk estimation code type and after a change in cross-talk estimation code type between t3-t4. Line 810 corresponds to a linear increase in cross talk coupling coefficients corresponding for example to an increase in temperature of the line. Line 812 corresponds to representative variations in the coefficients.

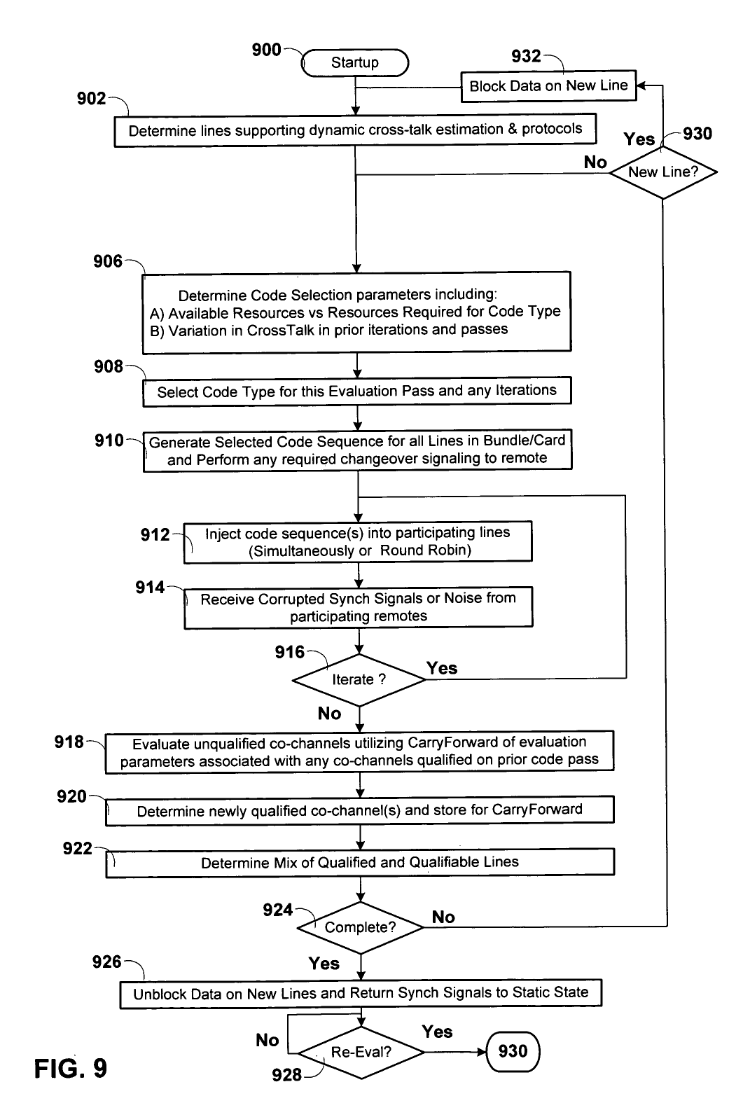

FIG. 9 is a process flow diagram of an embodiment of the processes performed by the crosstalk estimators shown in FIGS. 2-3. After startup 900 control passes to process 902 in which a determination is made as to the digital subscriber lines which support dynamic cross-talk estimation and the protocols thereon. Next control passes to process 906. In process 906 code selection parameters are determined. These include a determination of available resources on the line card, e.g. processor bandwidth, memory, and latency constraints versus the resources required for the supported cross talk estimation code types. Additionally, the variation in cross-talk in prior iterations of the same code type and predecessor code types used during estimation is determined. Based on these determinations a code type is selected in process 908 for this evaluation pass and any iterations thereof. Next control passes to process 910 in which the unique code vectors associated with the selected cross-talk estimation code type are generated.

Then in process 912 these unique code vectors are injected into the synchronization symbols of those communication channels which support dynamic synchronization symbol modulation. Next in process 914 the corrupted synchronization signals or noise associated with the corruption of same are received from participating remote modems and readied for evaluation. If iteration or repetition of the code injection is to take place that determination in decision process 916 results in the return to process 912 for a subsequent injection of the unique code sequences into the next corresponding sets of synchronization symbols via modulation thereof for example. Control then passes to process 918.

In process 918, in an embodiment of the invention, unqualified co-channels are evaluated utilizing carry forward of evaluation parameters associated with any co-channels qualified on a prior pass with a different cross-talk estimation code type. Then in process 920 a determination is made as to any newly qualified co-channel(s) which can be used on a subsequent pass if evaluation is not complete for all co-channel coupling coefficients. In process 922 the mix of qualified and unqualified co-channel coupling coefficients is determined. Then in process 924 a determination is made as to whether crosstalk channel estimation is complete. If not then control returns to optional decision process 930. In an embodiment of the invention this decision process determines if a new communication channel is being initialized. If it is control passes to process 932 in which data transmission is blocked on the new line. Only modulation of the synchronization symbol of the new line is effected. Control then passes to process 902. Alternately if in decision process 930 no new communication channel is detected, then control passes to process 906 for the determination of code selection parameters for the next estimation pass.

Alternately, if in decision process 924 the crosstalk estimation is complete, then control passes to process 926 in which in an embodiment of the invention, data transmission on any new communication channels is unblocked and synchronization symbols are returned to the static state. Finally, in decision process 928 a determination is made as to when to resume crosstalk estimation. An affirmative determination results in passing control to optional decision process 930.

The foregoing description of a preferred embodiment of the invention has been presented for purposes of illustration and description. It is not intended to be exhaustive or to limit the invention to the precise forms disclosed. Obviously many modifications and variations will be apparent to practitioners skilled in this art. It is intended that the scope of the invention be defined by the following claims and their equivalents.

What is claimed is:

1. A line card configured to couple to a plurality of digital subscriber lines to support multi-tone modulation of communications channels thereon; and the line card comprising;
a co-channel estimator configured to estimate co-channel crosstalk coupling coefficients among selected pairs of the plurality of subscriber lines at levels for which the total crosstalk into a selected victim line among the plurality of digital subscriber lines substantially corresponds to the sum of the products of the corresponding crosstalk coupling coefficient for each remaining disturber one of the plurality of subscriber lines and the corresponding substantially unique vector transmitted thereon; and
a code selector coupled to the co-channel estimator and configured to select a cross-talk estimation code type and for generating substantially unique code vectors derived there from for injection into selected ones of the plurality of subscriber lines.

2. The line card of claim 1, wherein the code selector further comprises:
a resource monitor to monitor available resources on the line card; and
a selector coupled to the resource monitor for selecting the cross-talk estimation code type for which the associated resource consumption falls within the available resources monitored by the resource monitor.

3. The line card of claim 1, wherein the co-channel estimator further comprises:
an estimator for estimating co-channel crosstalk coupling coefficients; and
a carry forward component coupled to the estimator for determining which co-channels estimated by the estimator qualify for inclusion in subsequent estimation with a different code type and for carrying forward said qualified co-channel estimates for such use by the estimator, thereby reducing processing complexity and time associated with the estimation performed by the co-channel estimator.

4. The line card of claim 1, further comprising:
an injector responsive to an initialization of a new one of the plurality of digital subscriber lines to order the injection of unique code vectors into selected ones of the plurality of digital subscriber lines in a round-robin fashion thereby limiting crosstalk coupling coefficient estimation by the co-channel estimator during each iteration to that associated with a single disturber among the plurality of digital subscriber lines.

5. The line card of claim 1, further comprising:
an injector to limit transmission on the newly activated communication channel during co-channel estimation exclusively to a corresponding one of the substantially unique code vectors from the code selector and without additional data transmission thereon.

6. The line card of claim 1, further comprising:
an injector which generates the unique code vector for each selected one of the plurality of digital subscriber lines by offsetting by a random amount unique to each selected one of the plurality of digital subscriber lines a seed vector of a selected crosstalk estimation code type selected by the code selector.

7. The line card of claim 1, having the co-channel estimator further configured to iteratively estimate crosstalk coupling vectors with each iteration including at least one portion overlapping with the estimation of a prior portion thereby reducing a time required for multiple iterations of the estimation of the cross-talk coupling coefficients of a selected code type.

8. The line card of claim 1, further comprising:
a memory coupled to the code selector and including selectable cross-talk estimation code type records for generating either substantially unique orthogonal code vectors associated with a first corresponding cross-talk estimation code type or substantially unique non-orthogonal code vectors associated with a second corresponding cross-talk estimation code type.

9. The line card of claim 1, further comprising:
a memory coupled to the code selector and including selectable cross-talk estimation code type records for generating either substantially unique binary value code vectors associated with a first corresponding cross-talk estimation code type or substantially unique complex value code vectors associated with a second corresponding cross-talk estimation code type.

10. The line card of claim 1, further comprising:
a memory coupled to the code selector and including selectable cross-talk estimation code type records each defining either functionally or physically substantially unique code vectors associated with the corresponding cross-talk estimation code type.

11. The line card of claim 1, further comprising:
a memory coupled to the code selector and including selectable cross-talk estimation code type records including at least two selected from a group of code types including: a Hadamard code type, a constant-amplitude zero-autocorrelation code type (CAZAC) and an M-sequence code type.

12. The line card of claim 1, having the code selector further configured to generate a hybrid-Hadamard code type having the property that the unique code vectors associated therewith exhibit orthogonality for both a constant weight function, together with a linearly varying function over time, thereby providing orthogonality of the unique code vectors for injection into each of the plurality of subscriber lines in the presence of linearly time varying crosstalk coupling coefficients among the plurality of digital subscriber lines.

13. The line card of claim 1, having the code selector further configured to generate hybrid-M-sequence code type having a first set of unique non-orthogonal vectors associated therewith for injection into each of the plurality of digital subscriber lines, and a second set of unique vectors derived from the first set of vectors, the substitution of which by the co-channel estimator during estimation of co-channels allows for a cross-talk estimation exhibiting an accuracy corresponding to that associated with the use of orthogonal vectors.

14. A method for estimating crosstalk coupling coefficients on a plurality of digital subscriber lines supporting multi-tone modulation of communications channels thereon; and the method comprising;
selecting a cross-talk estimation code type;
injecting the unique code vectors associated with the code type selected in the selecting act into selected ones of the plurality of subscriber lines; and
estimating co-channel crosstalk coupling coefficients among selected pairs of the plurality of subscriber lines at levels for which the total crosstalk into a selected victim line among the plurality of digital subscriber lines substantially corresponds to the sum of the products of the corresponding crosstalk coupling coefficient for each remaining disturber one of the plurality of subscriber lines and a corresponding substantially unique vector transmitted thereon.

15. The method for estimating crosstalk coupling coefficients of claim 14, further comprising:
monitoring available resources for modulation of communication channels on the plurality of digital subscriber lines; and
selecting the cross-talk estimation code type for which the associated resource consumption falls within the available resources monitored in the monitoring act.

16. The method for estimating crosstalk coupling coefficients of claim 14, further comprising:
estimating co-channel crosstalk coupling coefficients;
determining which co-channels estimated by the estimator qualify for inclusion in subsequent iterations of estimation in the estimating act; and
carrying forward said qualified co-channel estimates for inclusion in a subsequent estimation with a different code type in the estimating act, thereby reducing processing complexity and time associated with the estimating act.

17. The method for estimating crosstalk coupling coefficients of claim 14, further comprising:
ordering the injection of unique code vectors into each of the plurality of subscriber lines in a round-robin fashion responsive to an initialization of a new communication channel on a corresponding one of the plurality of digital subscriber lines, thereby limiting crosstalk coupling coefficient estimation in the estimating act during each iteration to that associated with a single disturber among the plurality of digital subscriber lines.

18. The method for estimating crosstalk coupling coefficients of claim 14, further comprising:
limiting transmission on the new data line during co-channel estimation in the estimating act exclusively to a corresponding one of the substantially unique code vectors and without additional data transmission thereon.

19. The method for estimating crosstalk coupling coefficients of claim 14, wherein the estimating act further comprises:
iteratively estimating crosstalk coupling vectors with each iteration including at least one portion overlapping with the estimation of a prior portion thereby reducing a time required for multiple iterations of the estimation of the cross-talk coupling coefficients of a selected code type.

20. A means for estimating crosstalk coupling coefficients on a plurality of digital subscriber lines supporting multi-tone modulation of communications channels thereon; and the means for estimating crosstalk comprising;
means for selecting a cross-talk estimation code type;
means for injecting the unique code vectors associated with the code type selected by the means for selecting into selected ones of the plurality of subscriber lines; and
means for estimating co-channel crosstalk coupling coefficients among selected pairs of the plurality of subscriber lines at levels for which the total crosstalk into a selected victim line among the plurality of digital subscriber lines substantially corresponds to the sum of the products of the corresponding crosstalk coupling coefficient for each remaining disturber one of the plurality of subscriber lines and a corresponding substantially unique vector transmitted thereon.

21. The means for estimating crosstalk coupling coefficients of claim 20, further comprising:
means for monitoring available resources for modulation of communication channels on the plurality of digital subscriber lines; and
means for selecting the cross-talk estimation code type for which the associated resource consumption falls within the available resources monitored by the means for monitoring.

22. The means for estimating crosstalk coupling coefficients of claim 20, further comprising:
means for estimating co-channel crosstalk coupling coefficients;
means for determining which co-channels estimated by the estimator qualify for inclusion in subsequent iterations of estimation by the means for estimating; and
means for carrying forward said qualified co-channel estimates for inclusion in a subsequent estimation with a different code type by the means for estimating, thereby reducing processing complexity and time associated with the estimating crosstalk coupling coefficients.

23. The means for estimating crosstalk coupling coefficients of claim 20, further comprising:
means for ordering the injection of unique code vectors into each of the plurality of subscriber lines in a round-robin fashion responsive to an initialization of a new one of the plurality of digital subscriber lines, thereby limiting crosstalk coupling coefficient estimation during each iteration to that associated with a single disturber among the plurality of digital subscriber lines.

24. The means for estimating crosstalk coupling coefficients of claim 20, further comprising:
means for limiting transmission of a new communication channel on a corresponding one of the plurality of digital subscriber lines during co-channel estimation exclusively to a corresponding one of the substantially unique code vectors and without additional data transmission thereon.

25. The means for estimating crosstalk coupling coefficients of claim 20, wherein the estimating act further comprises:
means for iteratively estimating crosstalk coupling vectors with each iteration including at least one portion overlapping with the estimation of a prior portion thereby reducing a time required for multiple iterations of the estimation of the cross-talk coupling coefficients of a selected code type.
